(19) United States
(12) Patent Application Publication
(10) Pub. No.: US 2009/0222333 A1
(43) Pub. Date: Sep. 3, 2009

(54) COMMUNITY BASED TARGETED ADVERTISING

(75) Inventor: PHILLIP A. RIVAS, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/039,400

(22) Filed: Feb. 28, 2008

(51) Int. Cl. G06Q 30/00; G06F 15/16; G06F 17/30

(52) U.S. Cl. 705/14; 709/206; 707/104.1

(57) ABSTRACT

Computing devices, computer-readable media, and methods are provided for facilitating community based targeted advertising. A message is received from a first user. At least one intended recipient of the message is determined. Additionally, at least one preferred active communication channel associated with the at least one intended recipient is determined. Supplemental information is selected based on one or more attributes associated with the at least one intended recipient. The message is combined with at least a portion of the supplemental information to create an enriched message. At least a portion of the enriched message is then communicated to the at least one intended recipient using the selected preferred communication channel or channels.

### BACKGROUND

Community based networking is becoming increasingly important, especially in the context of the emerging mobile advertising market and the highly competitive online advertising market. Advertising solutions often incorporate targeted advertising, which enables advertisers to broaden the reach, relevance, and timeliness of advertising data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention allow for providing community based targeted advertising. Users may communicate messages to other users of a network. The messages are intercepted by a server that enriches the messages based on attributes of the intended recipient and the content of the message. Messages are enriched by combining the messages with advertisements. Embodiments of the present invention provide for targeted advertising in a peer-to-peer network that interfaces with a server. Further embodiments of the present invention provide for community based targeted advertising in a server based network.

Further embodiments of the present invention allow for including links to websites and product availability information in the enriched message. Still further embodiments of the present invention provide for including enriching information based on the location of the intended recipient. Embodiments of the invention also allow for choosing appropriate enriching information based on the active communication channels of the intended recipients.

According to an embodiment of the invention, a computing device may be provided that facilitates community based targeted advertising by utilizing a server that enriches user messages with relevant advertising content. The computing device may comprise an input/output component for managing communication traffic between users and the server. The computing device may further comprise a channel selection component that selects appropriate communication channels through which to send enriched messages, an ad selection component for selecting appropriate advertising information, and a website management component for managing a website.

These and other aspects of the invention will become apparent to one of ordinary skill in the art upon a reading of the following description, drawings, and the claims.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary network architecture in accordance with an embodiment of the present invention;

FIG. 3 is a block diagram of a portion of an exemplary server computing device in accordance with an embodiment of the present invention;

FIG. 4 is a flow diagram illustrating an exemplary method for facilitating community based targeted advertising in accordance with an embodiment of the present invention; and

FIG. 5 is a flow diagram illustrating an exemplary method for facilitating community based targeted advertising in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

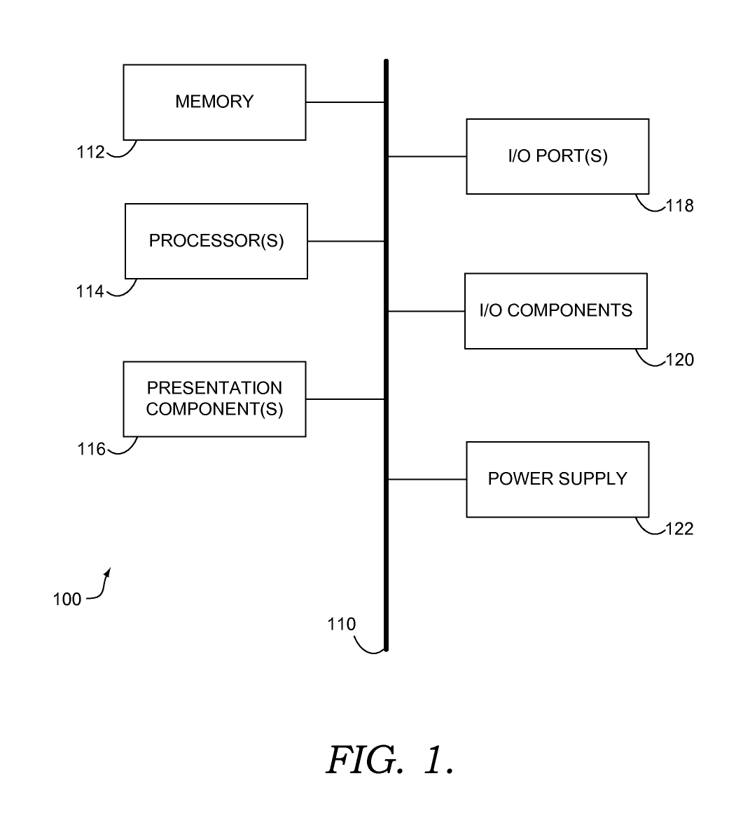

An exemplary operating environment in which various aspects of the present invention may be implemented is described below in order to provide a general context for various aspects of the present invention. Referring initially to FIG. 1, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated. In one embodiment, computing device 100 is a personal computer. But in other embodiments, computing device 100 may be a cell phone, smartphone, digital phone, handheld device, BlackBerry®, personal digital assistant (PDA), or other device capable of executing computer instructions.

The invention may be described in the general context of computer code or machine-useable instructions, including computer-executable instructions such as program modules, being executed by a computer or other machine, such as a PDA or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media. Computer storage media includes both volatile and nonvolatile, removable and non-removable media implemented in any method or technology for storage of information such as computer-executable instructions, data structures, program modules or other data. Computer readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

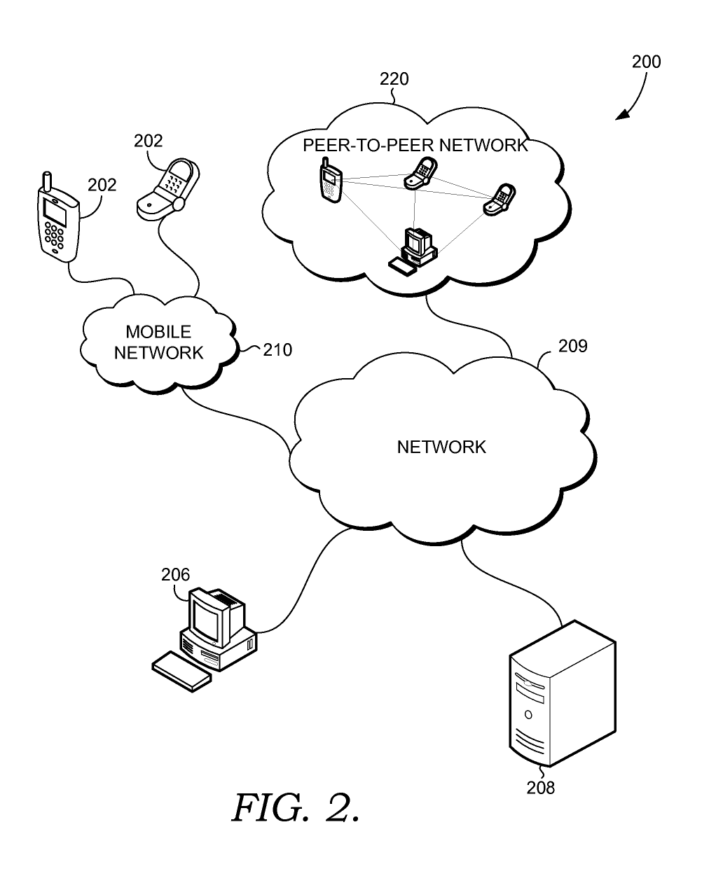

Turning to FIG. 2, a block diagram depicting an exemplary networking architecture 200 for implementing an embodiment of the present invention is shown. The networking architecture 200 may include one or more user communication devices 202, one or more user computing devices 206, one or more peer-to-peer networks 220, and a server 208, all of which may communicate via network 209. User communication devices 202 and user computing devices 206 may further be connected to network 209 via mobile, or wireless, networks 210. Networking architecture 200 is merely an example of one suitable networking environment and is not intended to suggest any limitation as to the scope of use or functionality of the present invention. Neither should networking architecture 200 be interpreted as having any dependency or requirement related to any single component or combination of components illustrated therein.

Network 209 may include any computer network or combination thereof. Examples of computer networks configurable to operate as network 209 include, without limitation, a wireless network, landline, cable line, fiber-optic line, local area network (LAN), wide area network (WAN), metropolitan area network (MAN), or the like. Network 209 is not limited, however, to connections coupling separate computer units. Rather, network 209 may also comprise subsystems that transfer data between servers or computing devices. For example, network 209 may also include a point-to-point connection, the Internet, an Ethernet, a backplane bus, an electrical bus, a neural network, or other internal system.

In an embodiment where network 209 comprises a LAN networking environment, components are connected to the LAN through a network interface or adapter. In an embodiment where network 209 comprises a WAN networking environment, components use a modem, or other means for establishing communications over the WAN, to communicate. In embodiments where network 209 comprises a MAN networking environment, components are connected to the MAN using wireless interfaces or optical fiber connections. Such networking environments are commonplace in offices, enterprise-wide computer networks, intranets, and the Internet. It will be appreciated that the network connections shown are exemplary and other means of establishing a communications link between the computers may also be used.

The user communication devices 202 may be any type of communication device, including, but not limited to, a computing device, such as device 100 described above with reference to FIG. 1. By way of example only and not limitation, the user communication device 202 may be an analog telephone, cellular phone, digital phone, smart phone, PDA, or the like. It should be noted that embodiments are not limited to implementation on such communication devices.

The user computing device 206 may be any type of computing device, such as device 100 described above with reference to FIG. 1. The user computer device 206 may be a user communication device 202 as described above, and to the extent that a user communication device 202 also comprises a computing device, such as device 100 in FIG. 1, the terms user communication device and user computing device are interchangeable. By way of example only but not limitation, the user computing device 206 may be a personal computer, desktop computer, laptop computer, handheld device, cellular phone, digital phone, smartphone, PDA, or the like. But it should be noted that embodiments of the present invention are not limited to implementation on such computing devices.

In some embodiments, user communication devices 202 and user computing devices 206 have the capability of identifying their location (e.g., home, work, public, etc.). That is, the devices have location awareness. This capability allows a communication device or computing device to identify its location on every network the device is connected to. The communication devices 202 and computing devices 206 may also transmit information identifying their geographic location to other components of the network. For example, user communication device 202 may be able to transmit information identifying its geographic location to server 208 or to user computing device 206. Additionally, in various embodiments, the location of such a device may be determined by other devices, such as those illustrated in FIG. 2. For example, a computing device 206 may be able to determine the location of another computing device 206 by reference to an IP (Internet Protocol) address.

Peer-to-peer network 220 may comprise a network that uses diverse connectivity between a plurality of participants in the network. In one embodiment, a peer-to-peer network environment configured for supporting communication within a social group may include client computing devices, server computing devices and a network. The client computing devices may operate as both clients and servers and may store or maintain supplemental information. The network may be a local or wide area network, or the Internet. The server computing devices may operate to distribute the supplemental information. In one embodiment, all operations of the community based targeted advertising platform are distributed among the client computing devices.

In another embodiment of a peer-to-peer network 220, the server computing devices may centralize specified operations performed in the peer-to-peer network environment, such as, for example, accounting operations, billing operations, or maintaining and distributing supplemental information. In that case, the peer-to-peer network environment may implement a mix of a centralized and a peer-to-peer (decentralized) architecture.

It will be readily appreciated by those skilled in the art that peer-to-peer network 220 may take many different forms, including modifications of the architecture described herein. This description is not intended to limit the configuration of such a peer-to-peer network, but rather is provided only as an example of such a configuration. Moreover, as shown in FIG. 2, the peer-to-peer network 220 may be configured so as to establish communication between the various nodes of the peer-to-peer network 220 and the network 209. In another embodiment, communication devices 202, computing devices 206, and server 208 may all be included within the peer-to-peer network 220. In further embodiments, the peer-to-peer network 220 may include various combinations of the devices illustrated in FIG. 2.

The server 208 may be a computing device and may include any type of application server, database server, or file server configurable to perform the methods described herein. In addition, the server 208 may be a dedicated or shared server. In an embodiment, two or more servers may be directly or indirectly connected to each other without using network 209. While the server 208 is illustrated as a single unit in FIG. 2, one skilled in the art will appreciate that the server 208 is scalable. For example, the server 208 may in actuality include 100 servers in communication. The single unit depictions are meant for clarity, not to limit the scope of embodiments in any form.

Components of the server 208 may include, without limitation, a processing unit, internal system memory, and a suitable system bus for coupling various system components, including one or more databases for storing information (e.g., files and metadata associated therewith). The server 208 may also include, or be given access to, a variety of computer-readable media and communication media. By way of example, and not limitation, computer-readable media may include computer-storage media. Additionally, in general, communication media enables each server to exchange data via network 209. More specifically, communication media may embody computer-useable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media.

As previously mentioned, in one embodiment, the present invention relates to facilitating community based targeted advertising by utilizing a server that enriches messages with relevant advertising content. Another embodiment relates to a mechanism for generating enriched messages based on various user and message attributes.

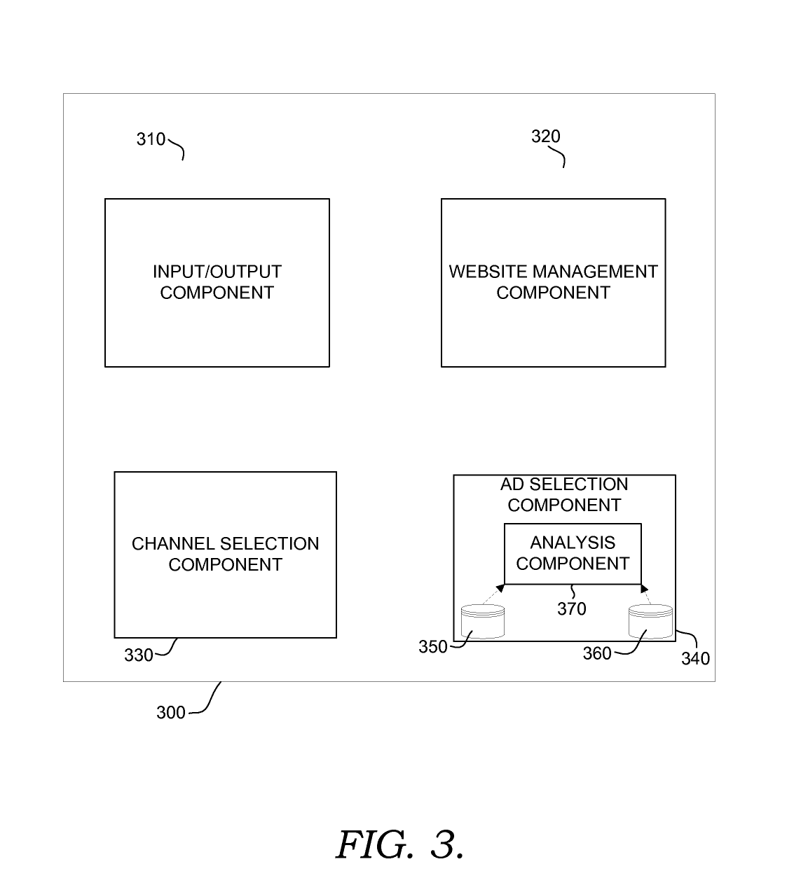

Turning to FIG. 3, a block diagram is shown, illustrating the relevant components of an exemplary server computing device 300 according to an embodiment of the present invention. An input/output component 310 is shown, and is operable to receive messages sent from users. The input/output component 310 is further operable to communicate messages, which may be enriched messages, to users. As used throughout this document, the term “message” is intended to mean a communication and may include, for example, a text message, an instant message, an email, or a web page notification. Messages may be configured and/or processed so that they are able to be delivered to the computing device 300 and user communication devices, as described above, with reference to FIG. 2.

Text messages, instant messages and email include all of the forms and variations thereof that are known in the art. As used herein, a web page notification means a notification that becomes perceivable by a user while the user is interacting with a web site. A web page notification may take any of various forms, including, but not limited to a pop-up message, a tone, an interactive button, a temporarily displayed portion of text, etc. In one embodiment, if a web page notification does not contain a complete message, it may be interactive so that a user can obtain a complete message by interacting with the notification such as, for example, by clicking on a pre-determined location with a mouse or other input tool.

According to an embodiment of the present invention, messages may be created using various languages known in the art. For example, in one embodiment, a message may be created using plain text, which generally denotes ordinary unformatted sequential text that is readable by users without having to be significantly processed. In another embodiment, a user may create a message using name-value pairs. Name-value pairs are data representations that computing systems and applications are able to easily read and use. Because computing systems and applications can be coded to implement associative arrays, name-value pairs can be used to create open-ended data structures that can be extended with little or no modification of existing code or data.

In a further embodiment, a message may be created using a simple grammar that is unique to the network in which it is used. A simple grammar may include particular rules and a particular vocabulary that enable computing device 300 to easily parse messages and ascertain the subject matter therein. For example, in one embodiment, a user may create a message that is intended to notify other members of his or her social network about a new product that he or she encountered. The message may use a simple grammar to indicate the type of product encountered, where it was encountered, the price associated with the product, and a review or other information regarding the product. In some embodiments, the simple grammar is defined by the user, whereas in other embodiments, the simple grammar is defined by the system.

In order to accomplish this message, in one embodiment, each part of the message may begin with a tag identifying the type of information to follow. In one embodiment, the tag may comprise a single word or small group of words that the computing device 300 is configured to recognize. In an embodiment, the computing device may recognize that it has encountered a tag, for example, when the word or group of words is followed or preceded immediately by a colon or some other identifying character. Using this tag recognition, the server can efficiently parse the text and use the subject matter included therein to select relevant supplemental information, as described more fully below.

For example, the user may wish to convey that he or she has located a coin purse designed by Gucci, that the purse costs $100 at Bob's Purse Store, and that Bob's Purse Store carries a hard to find blue version of the purse. In that case, the user may begin each portion of a message with tags that indicate the type of information that follows. The resulting message may read “item: Gucci coin purse location: Bob's Purse Store price: $100 review: they have hard to find blue!”. In this example, “item:” “location:” “price:” and “review:” are tags that indicate the type of information that follows.

The message may also contain an opening tag that indicates to the computing device 300 that the message comprises a notification of a new product. For example, the message may have an opening tag that reads “[USER]-(imho:cool)”, where [USER] may be an identifying tag corresponding to the user, “imho:cool” may be a tag that indicates to the server that a favorable review of a product follows.

The computing device 300 of FIG. 3 may further comprise a website management component 320. The website management component 320 is operable to maintain a website associated with computing device 300. The website management component 320 may facilitate various operations known in the art to be related to hosting a website. The website management component 320 may further enable the display of web page notifications as well as user interfaces that enable users to interact with the web page. The website management component 320 may, in other embodiments, facilitate user interfaces that enable users to communicate with other users within a social group, browse various social groups or other user profiles, download content and post messages to a web page. In further embodiments, the website management component 320 may enable users to register with social groups, to sign up for various types of service, to submit preferences regarding their services, or to interact with other groups. It will be readily appreciated by those skilled in the art that a website management component 320 may perform many other functions and operations commonly associated with maintaining a website.

With continued reference to FIG. 3, the computing device 300 may further comprise a channel selection component 330 that is operable to determine appropriate communication channels for use in communicating with users. The channel selection component 330 may determine active communication channels associated with particular users. An active communication channel is a path of communication that is associated with a particular user's presence. As used herein, the term “presence” provides information regarding the status of any communication channel through which a user can receive communication via a communication device. A user's presence is defined as a function of time. That is, for example, a user may be actively able to receive communication via a particular communication channel at a first time of day but not at a later time of day.

In one embodiment, a user's presence may correspond to a particular type of user communication device. For example, at a particular moment in time, a user may have his or her cell phone turned on and may also be logged into an email account via a personal computer. In that case, the user's presence may comprise the user's cell phone and its corresponding communications services, as well as the user's personal computer and its corresponding communications services. In another embodiment, a user's presence may correspond to a particular service, which may or may not be utilized through the same communication device. For example, a user may be using his or her computer and may be logged into an email account and an instant messaging service. That user's presence may comprise the user's email account as well as the user's instant messaging service. In further embodiments, a user's presence may refer to various combinations of the types of scenarios described above, and may include, for example, any of the components shown in FIG. 2.

The channel selection component 330 may further be operable to select one or more active communications channels through which to communicate with a user. In an embodiment of the present invention, this determination may be based upon active communication channels that are associated with a user, as well as preferred communication channels. Preferred communication channels are channels of communication that a particular user prefers to use to receive enriched messages. A user may establish rules that dictate through which communication channels the user will receive communication.

For example, in an embodiment of the present invention, a user may submit preferences to a server, such as one hosted by computing device 300, that comprise a set of rules. The rules may dictate that any communications directed to the user are to be sent to the user's email account if the user is logged on to that account. The rules may further specify that if the user is not logged on to the user's email account, communications are to be sent through the user's instant messaging service, so long as the user is logged on to the instant messaging service. In various embodiments, any number of situations and combinations of situations or events may provide the basis for invoking one or more preference rules. These rules establish a list of preferred communication channels, communication channels through which the user prefers to receive communication. In various embodiments, the list of preferred communication channels may be ranked in order of preference.

The channel selection component 330 may use a list of preferences, a set of rules, or other form of indication to determine, for a particular user at a particular time, which of the active communication channels constitutes a preferred communication channel. The channel selection component 330 may then select the preferred channel or channels so that any communications sent from computing device 300 to the user will then be sent via the selected channel or channels.

The computing device 300 may further comprise an ad selection component 340 for selecting supplemental information to be combined with a message to create an enriched message. In one embodiment supplemental information is stored in an information database 350, from which it is retrieved upon selection. In another embodiment, for example, the ad selection component 340 may retrieve supplemental information from another device or system configured to select supplemental information, and upon receiving the supplemental information, ad selection component 340 may tailor or modify the supplemental information to be contextually relevant to the user, as described below.

Supplemental information may be any information or content that may enrich the experience of a user receiving a message. For instance, in one embodiment, supplemental information may include information regarding a product or service that is the subject of a message. For example, such information may describe the product or service, may include prices associated with the product or service, may include availability of the product or service in certain locations or at certain times of the day or year, or may include any other information that a consumer may find helpful.

In another embodiment, supplemental information may include links to websites, contact information, or contextually relevant information. For example, if a message is sent from a user that references a particular product such as the Gucci coin purse discussed above, supplemental information may include one or more links to retailer websites that offer the coin purse for sale. Additionally, in an embodiment, the supplemental information may include contact information such as addresses and phone numbers for retailers that sell the coin purse.

In a further embodiment, supplemental information may include information that is contextually relevant to the particular recipient of a message. For example, the supplemental information may include reviews by other consumers of a particular product or service, information regarding outlets located in close proximity to the recipient's geographical location that offer the product or service, and pricing information corresponding to outlets located near the recipient. Additionally, in a further embodiment, the supplemental information may include information regarding the availability of the product or service in the proximity of the recipient's geographical location.

In an embodiment of the present invention, supplemental information may include targeted advertisements for products or services. For example, the message regarding the Gucci coin purse may be enriched with supplemental information that includes advertisements for the Gucci coin purse or other related coin purses or products. As will be appreciated by those skilled in the art, such advertisements may be targeted to particular recipients based on relevance. For example, an advertisement may correspond to a particular retailer in the recipient's geographical area, a type of retailer that the recipient or other similarly situated consumers frequents, or other products and services that the recipient or other similarly situated consumers is known to have purchased in the past.

The ad selection component 340 may comprise an analysis component 370 that selects supplemental information based on the subject matter, other contextual factors such as geographic locations, various attributes associated with the intended recipient of a message. These attributes may include demographic information such as age, gender, place of residence, etc. In one embodiment, these attributes and others are stored in a user profile database 360. Additionally, the attributes may include the recipient's current geographical location, which may be ascertainable via properties associated with the recipient's communication device and which are well known in the art. Attributes may further include historical data regarding the recipient's network activity, such as purchases that the recipient has made online, websites that the recipient has visited, and searches that the recipient has performed. It will be readily appreciated by those skilled in the art that any combination of the above attributes, including other various attributes not listed herein, may be used to target advertising to a particular recipient.

To facilitate selection of supplemental information to be combined with a message, the analysis component 370 may ascertain one or more selected preferred communication channels from the channel selection component 330. In one embodiment, the analysis component 370 selects supplemental information based on the types of information that are best communicated via the preferred communication channels selected by the channel selection component 330. For example, the analysis component 370 may select advertisements and pricing information or the like where the preferred communication channel corresponds to a cell phone. On the other hand, if the preferred communication channel corresponds to a recipient's personal computer, for example, it may be possible to provide a much richer experience to the recipient. In that case, the analysis component 370 may select supplemental information that further comprises links to web sites, audio media, video media, or other content best suited for receipt at a personal computer. In various embodiments, the analysis component 370 references information from the profile database 360, geographic location information, information regarding the subject matter of a message, and various other types of information known in the art when selecting supplemental information from the information database 350.

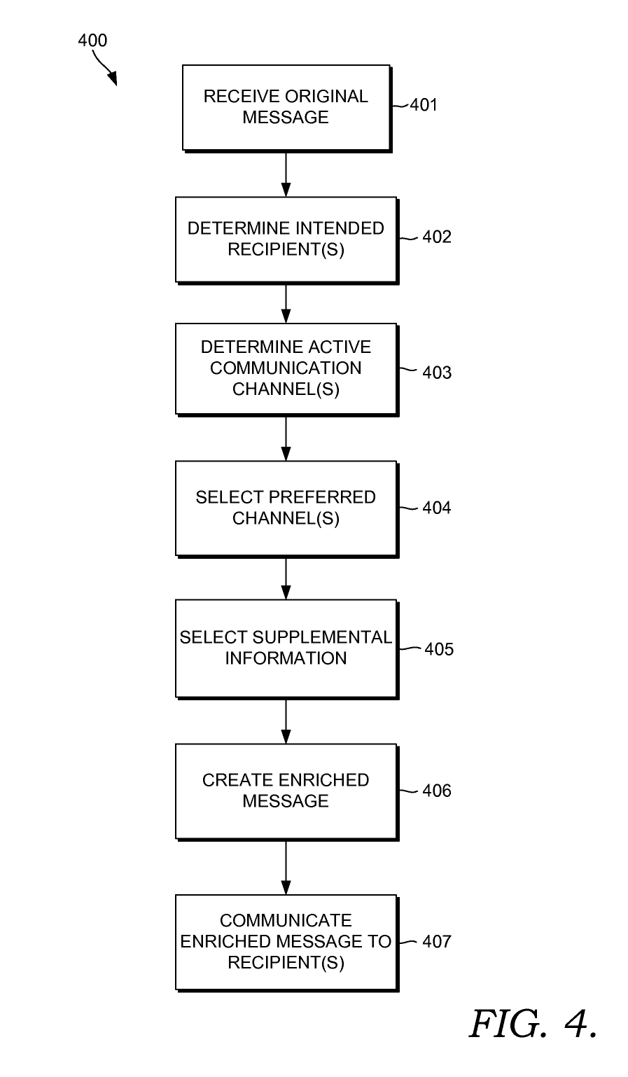

Turning now to FIG. 4, a flow diagram is shown which illustrates an exemplary method 400 for facilitating community based targeted advertising in accordance with an embodiment of the present invention. Initially, at step 401, an original message is received from a first user. As described above, the original message may comprise, for example, an email, a text message, or an instant message. As illustrated at step 402, the intended recipients for the original message are determined.

In an embodiment of the present invention, an intended recipient may be anyone, including, for example, a member of a social group or peer-to-peer network associated with the first user. Additionally, in another embodiment, the first user and the intended recipients may be registered with a social networking system. In one embodiment, the first user and the intended recipients may belong to the same social group within a social networking system. In another embodiment, the first user and the intended recipients may belong to different social groups. In a further embodiment, the intended recipients may not belong to any social group. The intended recipient of a message may also be a website, server, or other non-human entity. These are only examples of what is intended to be included within the meaning of the term “intended recipient,” and are not meant to limit the scope of this term.

In an embodiment of the present invention, the first user may specify that an intended recipient that is a member of the first user's social group is to be sent the entire message, whereas an intended recipient that is not a member of the first user's social group is to be sent only a portion of the message. Additionally, in further embodiments of the present invention, the first user may indicate that certain members of a social group are to receive certain portions of a message, whereas certain other members are to receive other portions. Any such rules for the apportionment of messages may be incorporated into various implementations of the present invention.

With continuing reference to FIG. 4, at step 403, active communication channels associated with the intended recipient or recipients are determined. As described above with reference to FIG. 3, in an embodiment, active communication channels may be defined based on an intended recipient's presence. Additionally, an intended recipient may be associated with one or more active communication channels. Of the active communication channels identified in this determination, preferred communication channels are selected, as shown at step 404.

At step 405, supplemental information is selected. As described above, with reference to FIG. 3, in one embodiment, supplemental information may include, for example, targeted advertising selected based on various attributes of the intended recipient. Additionally, supplemental information may be selected based on the types of preferred communication channels selected at step 404. In further embodiments, supplemental information may be selected based on a combination of the above factors, alone, or in combination with various other contextual factors.

Once selected, the supplemental information is combined with the original message to create an enriched message, as shown at step 406 of FIG. 4. Combining supplemental information with the original message may include, without limitation, attaching the supplemental information to the original message, embedding the supplemental information within the original message, or providing the supplemental information simultaneously with the original message. In other embodiments, the original message may be modified to include the supplemental information. The enriched message, or at least a portion thereof, which consists of at least the original message and the supplemental information is communicated to the intended recipient or recipients, as shown at step 407 of FIG. 4.

It will be readily appreciated by those skilled in the art that methods similar to the one illustrated in FIG. 4 may be practiced with any number of modifications and may not necessarily be performed in the same order as described in FIG. 4 and the preceding text. The methods described herein are intended to be exemplary in nature and are not intended to be limited to being necessarily performed in the order described herein.

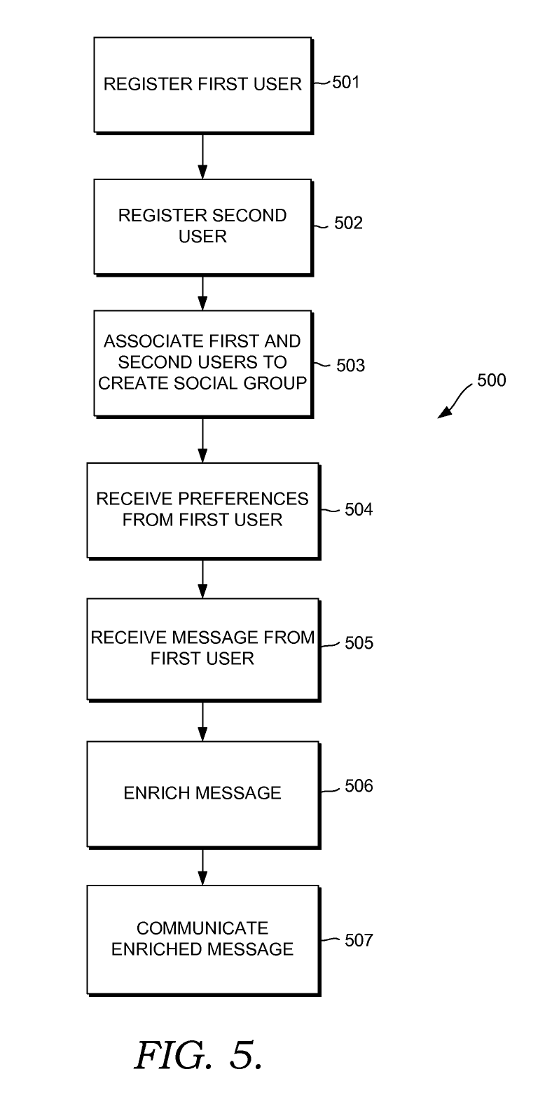

Turning now to FIG. 5, a flow diagram is shown which illustrates an exemplary method 500 for facilitating community based targeted advertising in accordance with an embodiment of the present invention. Initially, at step 501, a first user registers with a system configured for implementing the present invention. Registering a user may comprise, for example, associating the user with a user profile, opening an account for the user, or any other such process that results in some record of the user being maintained such that the record can be referenced at a later time. At step 502, at least one second user is registered. Then, as shown at step 503, the at least one second user is associated with the first user to create a social group.

In an embodiment of the present invention, a social group may consist of two or more users that communicate with each other via user communication devices such as those described above with reference to FIG. 2. In one embodiment the social group may consist of an organization of users maintained by a central server in a typical client-server network. In another embodiment, the social group may consist of a group of users whose communication is supported by a peer-to-peer network environment or an environment that comprises some combination of peer-to-peer and server-based characteristics.

At step 504, preferences are received from the first user. It will be apparent to those skilled in the art that preferences may similarly be received from the at least one second user, as well. Preferences may include rules defined by a user that dictate how messages are to be communicated. In an embodiment, preferences may indicate what portions of messages are to be distributed to which users. Additionally, in other embodiments, preferences may indicate preferred communication channels for certain types of messages or for all messages. In various embodiments, preferences may further include any number of configuration attributes that a user wishes to incorporate into the user's social group networking experience, including preferences that affect the experience of other users.

As shown at step 505, a message is received from the first user. The message is enriched with supplemental information at step 506. The message may be enriched with supplemental information by combining relevant supplemental information with the message. At step 507, the enriched message is communicated to the at least one second user. The communication of the enriched message may be accomplished using a preferred communication channel and in accordance with preferences received from the first user and/or the at least one second user.

It will be readily appreciated by those skilled in the art that methods similar to the one illustrated in FIG. 5 may be practiced with any number of modifications and may not necessarily be performed in the same order as described in FIG. 5 and the preceding text. The methods described herein are intended to be exemplary in nature and are not intended to be limited to being necessarily performed in the order described herein.

As can be understood, embodiments of the present invention provide for facilitating community based targeted advertising by utilizing social groups communicating within a network. In various embodiments, the network may comprise a peer-to-peer network, a client-server network, or a mix of the two. Further embodiments of the present invention provide for enriching messages received from a first user at a server. Messages may be enriched with advertisements or other contextually relevant supplemental information.

Still further embodiments of the present invention allow a first user to control the membership and preferences for a particular social group. Additional embodiments of the present invention allow for visitors of a website to view enriched messages, whether or not the visitors are registered or members of any social groups or peer-to-peer networks.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media having computer-executable instructions embodied thereon for performing a method for facilitating community based targeted advertising, the method comprising:
receiving an original message sent from a first user,
determining at least one intended recipient of the original message;
determining at least one active communication channel associated with the at least one intended recipient;
selecting at least one preferred active communication channel associated with the at least one intended recipient;
selecting supplemental information based on one or more attributes associated with the at least one intended recipient, wherein said attributes comprise the at least one preferred active communication channel and data associated with the at least one intended recipient, wherein said data is organized in a recipient profile;
combining the original message with at least a portion of the supplemental information to create an enriched message, wherein the enriched message comprises the original message and the supplemental information;
communicating at least a portion of the enriched message to the at least one intended recipient using the selected at least one preferred active communication channel.

2. The one or more computer-readable media of claim 1, wherein the first user and the at least one intended recipient are members of a peer-to-peer network.

3. The one or more computer-readable media of claim 1, wherein the original message comprises one of a text message, an email, and an instant message.

4. The one or more computer-readable media of claim 3, wherein said original message further comprises a set of characters, the set of characters comprising one of plain text and name-value pairs.

5. The one or more computer-readable media of claim 3, wherein said original message further comprises a set of characters arranged according to a simple grammar.

6. The one or more computer-readable media of claim 1, wherein the at least one intended recipient comprises at least one registered user, wherein said at least one registered user comprises at least one user associated with a recipient profile.

7. The one or more computer-readable media of claim 1, wherein the at least one intended recipient comprises at least one unregistered user, wherein said at least one unregistered user comprises at least one user not associated with a recipient profile.

8. The one or more computer-readable media of claim 7, wherein the at least one unregistered user is provided access to the original message via a website.

9. The one or more computer-readable media of claim 1, wherein the supplemental information comprises at least one advertisement.

10. The one or more computer-readable media of claim 9, wherein said at least one advertisement comprises promotional material represented by at least one of graphical media, audio media, and video media.

11. The one or more computer-readable media of claim 1, wherein said at least one active communication channel is associated with at least one presence associated with the at least one recipient.

12. The one or more computer-readable media of claim 11, wherein said at least one presence comprises at least one active connection to a user communication device via at least one of a network service, an email service, a mobile phone service, and a website.

13. The one or more computer-readable media of claim 12, wherein the at least one active connection comprises an interface with at least one pre-existing social network.

14. The one or more computer-readable media of claim 1, wherein said one or more attributes further comprises a geographic location associated with said at least one recipient.

15. A method for facilitating community based targeted advertising, the method comprising:
registering a first user;
registering at least one second user;
associating the at least one second user with the first user to create a social group;
receiving one or more preferences from the first user, wherein said preferences comprise one or more rules associated with communicating messages to the at least one second user;
receiving a message from the first user;
enriching the message with supplemental information to create an enriched message; communicating at least a portion of the enriched message to the at least one second user.

16. The method of claim 15, wherein said message comprises a notification regarding at least one of a product and a service.

17. The method of claim 16, wherein said enriched message comprises said notification and information regarding the availability of said at least one of a product and a service.

18. A computing device operable to facilitate community based targeted advertising, the computing device comprising:
an input/output component for receiving messages from users and for communicating enriched messages to users;
a channel selection component for determining at least one preferred communication channel for communicating enriched messages to a user;
an ad selection component for enriching messages with supplemental information; and
a website management component for maintaining a community based website and facilitating the exchange of enriched messages within a community of social groups.

19. The computing device of claim 18, wherein determining at least one active communication channel associated with a user comprises determining whether at least one communication channel associated with the user is active and determining whether at least one preferred communication channel associated with the user is active.

20. The computing device of claim 18, wherein the ad selection component comprises:
at least one user profile database, the user profile database comprising facts associated with users;
at least one information database, the information database comprising supplemental information;
an analysis component that references the at least one user profile database and selects supplemental information from the at least one information database, wherein said supplemental information is selected based on at least one of a user profile, a communication between users, and an active communication channel.
